(19) United States
(12) Patent Application Publication
(10) Pub. No.: US 2024/0144343 A1
(43) Pub. Date: May 2, 2024

(54) APPARATUS AND METHOD FOR PROVIDING INTERIOR INFORMATION

(71) Applicant: Gallery-T CO., Ltd, Seoul (KR)

(72) Inventor: Koo Hyoung KIM, Seoul (KR)

(21) Appl. No.: 17/974,511

(22) Filed: Oct. 26, 2022

(51) Int. Cl. G06Q 30/0601; G06T 7/90; G06V 10/74; G06V 10/764

(52) U.S. Cl. CPC G06Q 30/0631; G06T 7/90; G06V 10/761; G06V 10/764; G06T 2207/10024

(57) ABSTRACT

A method of providing interior information according to an embodiment includes identifying a type of accessory included in an query image received from a user terminal, determining a type of space corresponding to the query image from the identified type of accessory, selecting a reference image classified as corresponding to the determined type of space from pre-stored reference images, and transmitting information on an accessory included in the selected reference image to the user terminal.

### STATEMENT REGARDING PRIOR DISCLOSURE BY THE INVENTOR OR A JOINT INVENTOR

Applicant hereby states that Korean patent publication No. 10-2022-0013653 published on Feb. 4, 2022, is a prior disclosure made directly or indirectly by the inventor(s), and the prior disclosure made by the inventor(s) do not qualify as prior art under the grace period exception of 35 USC § 102(b)(1).

Further, the content of the inventor's prior disclosure of Korean patent publication No. 10-2022-0013653 is hereby incorporated by reference in its entirety.

### 1. FIELD OF THE INVENTION

The present invention relates to the field of information provision. More specifically, the present invention relates to an apparatus and method for providing interior information suitable for a user's residential space according to a request of a user terminal.

### 2. DISCUSSION OF RELATED ART

Traditionally, residential spaces, such as houses, have tended to be used only as spaces for people to sleep, rest, and the like.

Therefore, the interior has been made for maintenance of old facilities and strengthening of safety.

However, as people's income levels and consciousness levels have increased and a culture of individual life has become more respected, residential spaces have been developed as customized spaces that meet individual tastes. Accordingly, a concept of the interior has also evolved from renovating a house to decorating a house.

Users directly visit nearby businesses, real estates, and places to which they have been introduced by acquaintances, etc., to find styles or accessories suitable for their residential spaces, which incurs a burden of time and money on the user. In addition, it is difficult for users without professional knowledge about interior to select accessories or colors suitable for their space.

The scale of the Korean interior market is estimated at about 28 trillion won as of 2018, and is expected to grow to over 41 trillion won in 2020. In line with the rapid growth of the interior market, there is a need for a method of allowing users to simply check information on interior styles or accessories suitable for their residential spaces instead of directly visiting several companies.

### SUMMARY OF THE INVENTION

The present invention provides an apparatus for providing interior information and a method of providing interior information by the same capable of providing information on an interior suitable for a user's residential space.

In addition, the present invention provides an apparatus for providing interior information and a method of providing interior information by the same capable of activating a user's purchase of accessories or a user's selection of a construction company by providing information that reflects the user's preferences.

According to an aspect of the present invention, a method of providing interior information according to an embodiment includes identifying a type of accessory included in an query image received from a user terminal, determining a type of space corresponding to the query image from the identified type of accessory, selecting a reference image classified as corresponding to the determined type of space from pre-stored reference images, and transmitting information on an accessory included in the selected reference image to the user terminal.

The determining of the type of space corresponding to the query image may include determining a type of space corresponding to the query image by comparing a type of accessory suitable for each space with the type of accessory included in the query image.

The transmitting of the information on the accessory to the user terminal may include transmitting, to the user terminal, information on a same type of accessory as the identified accessory from accessories included in the selected reference image.

The method may further include: identifying a color of the accessory included in the query image; and determining an interior style of the query image from the identified color of the accessory, in which the transmitting of the information on the accessory to the user terminal may include transmitting, to the user terminal, the information on the accessory that corresponds to the determined type of space and is included in a reference image classified as having the determined interior style.

The method may further include transmitting, to the user terminal, information on a construction company that corresponds to the determined type of space and corresponds to the reference image classified as having the determined interior style.

The transmitting of the information on the accessory to the user terminal may include: selecting an accessory unsuitable for the identified interior style from the accessories included in the query image; and transmitting, to the user terminal, information on a same type of accessory as the unsuitable accessory from the accessories included in the selected reference image.

The determining of the interior style of the query image may include determining an interior style of the query image by comparing a color suitable for each interior style with the color of the accessory included in the query image.

The method may further include: receiving information on the interior style from the user terminal; and transmitting, to the user terminal, information on a construction company that corresponds to the determined type of space and corresponds to a reference image classified as having the received interior style.

According to another aspect of the present invention, an apparatus for providing interior information includes: an image analysis unit configured to identify a type of accessory included in a query image received from a user terminal; an interior analysis unit configured to determine a type of space corresponding to the query image from the identified type of accessory and select a reference image classified as corresponding to the determined type of space from pre-stored reference images; and a communication unit configured to transmit information on the accessory included in the selected reference image to the user terminal.

The interior analysis unit may determine the type of space corresponding to the query image by comparing a type of accessory suitable for each space with the type of accessory included in the query image.

The communication unit may transmit, to the user terminal, information of a same type of accessory as the identified accessory from the accessories included in the selected reference image.

The image analysis unit may identify a color of the accessory included in the query image, the interior analysis unit may determine an interior style of the query image from the identified color of the accessory, and the communication unit may transmit, to the user terminal, information on an accessory that corresponds to the determined type of space and is included in a reference image classified as having the determined interior style.

The communication unit may transmit, to the user terminal, information on an accessory that corresponds to the determined type of space and corresponds to information on a construction company corresponding to the reference image classified as having the determined interior style.

The interior analysis unit may determine an interior style of the query image by comparing a color suitable for each interior style with the color of the accessory included in the query image.

The communication unit may receive information on an interior style from the user terminal, and transmit, to the user terminal, information on a construction company that corresponds to the determined type of space and corresponds to a reference image classified as having the received interior style.

### BRIEF DESCRIPTION OF THE DRAWINGS

In order to more fully understand the accompanying drawings cited herein, a brief description of each drawing is provided:

FIG. 1 is a diagram illustrating a user terminal and an apparatus for providing interior information according to an embodiment;

FIG. 2 is a flowchart for describing a method of providing interior information according to an embodiment;

FIG. 3 is an exemplary diagram illustrating interior-related information extracted from a reference image;

FIG. 4 is an exemplary diagram illustrating a classification result of reference images according to the interior-related information;

FIG. 5 is an exemplary diagram illustrating a type of accessories identified in a query image;

FIG. 6 is a diagram for describing a method of determining a type of space corresponding to a query image based on the type of accessories identified in the query image;

FIG. 7 is an exemplary diagram illustrating a color of accessories identified in the query image;

FIG. 8 is a diagram for describing a method of determining an interior style of a query image based on the color identified in the query image;

FIG. 9A is an exemplary diagram illustrating information on an accessory provided to a user terminal, and FIG. 9B is an exemplary diagram illustrating information on a construction company provided to the user terminal;

FIG. 10 is a block diagram illustrating a configuration of an apparatus for providing interior information according to an embodiment; and

FIG. 11 is a block diagram illustrating a configuration of the user terminal according to the embodiment.

### DETAILED DESCRIPTION OF EXEMPLARY EMBODIMENTS

The present invention may be variously modified and have several exemplary embodiments. Therefore, specific exemplary embodiments of the present invention will be illustrated in the accompanying drawings and be described in detail in the present specification. However, it is to be understood that the present invention is not limited to a specific exemplary embodiment, but includes all modifications, equivalents, and substitutions without departing from the scope and spirit of the present invention.

When it is decided that the detailed description of the known art related to the present invention may unnecessarily obscure the gist of the present invention, detailed description thereof will be omitted. In addition, numbers (for example, first, second, etc.) used in the description process of the present specification are only identification symbols for distinguishing one component from other components.

Further, in the present specification, it is to be understood that when one component is referred to as “connected to another component,” the one component may be directly connected to another component or may be connected to another component through still another component unless explicitly described to the contrary.

In addition, in the present specification, in components expressed as “part (unit),” “module,” etc., two or more components may be combined into one component, or one component may be divided into two or more components for each subdivided function. In addition, each of the components to be described below may additionally perform some or all of the functions of other components in addition to the main functions of the components, and some of the main functions of the components may be performed exclusively by other components.

Hereinafter, embodiments according to the technical spirit of the present invention will be described in detail in turn.

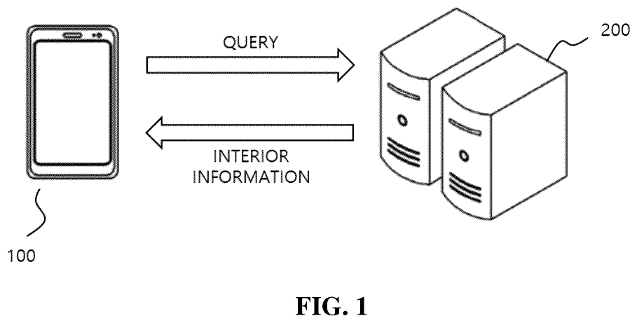

FIG. 1 is a diagram illustrating a user terminal 100 and an apparatus for providing interior information 200 (hereinafter, information providing apparatus) according to an embodiment.

Referring to FIG. 1, the user terminal 100 may provide a query for the interior of a predetermined space, for example, a user's residential space, to the information providing apparatus 200. The information providing apparatus 200 may provide interior information suitable for a predetermined space by analyzing the query received from the user terminal 100.

In this case, the query provided from the user terminal 100 to the information providing apparatus 200 may include image data, text data, and/or video data. Similarly, the interior information transmitted to the user terminal 100 by the information providing apparatus 200 may include image data, text data, and/or video data.

The interior information provided to the user terminal 100 by the information providing apparatus 200 may include information on accessories suitable for a user's predetermined space, information on a construction company for interior construction of a predetermined space, and the like. The information providing apparatus 200 may provide, as information on accessories, information such as information on a name of an accessory, an image of an accessory, a price of an accessory, a sales site address of an accessory, and a user evaluation of an accessory to the user terminal 100. In addition, the information providing apparatus 200 may provide, as information on a construction company, information such as a name of a construction company, construction cost, construction performance of a construction company, a site address of a construction company, and a user evaluation of a construction company to the user terminal 100.

The user terminal 100 may display interior information provided from the information providing apparatus 200. Through the displayed interior information, the user can check which accessory is suitable for his or her space and which company to use for interior construction for his or her space.

According to an embodiment of the present invention, since a user may secure information on accessories or information on a construction company suitable for his or her residential space or the like by simply inputting a query through his or her terminal, inconvenience of a user directly visiting interior companies may be reduced.

FIG. 1 illustrates a smartphone as the user terminal 100, but the user terminal 100 is not limited to the smartphone. That is, the user terminal 100 may include various devices having communication and display functions, such as a smart phone, a desktop PC, a tablet PC, a notebook computer, and a wearable device.

In an embodiment, an application for providing a query to the information providing apparatus 200 and receiving interior information from the information providing apparatus 200 may be installed in the user terminal 100. The corresponding application may be transmitted to the user terminal 100 from the information providing apparatus 200, an application store, or the like, and installed in the user terminal 100. A user may input a query for interior information by executing an application installed on the user terminal 100, and may check interior information received from the information providing apparatus 200.

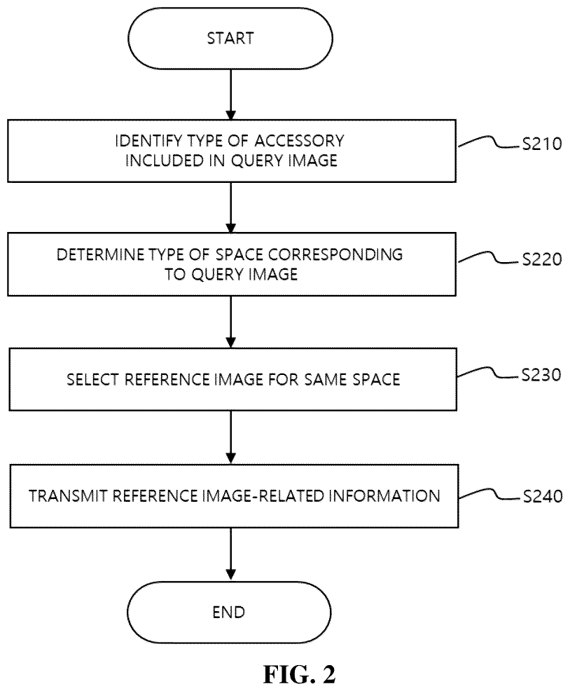

Hereinafter, operations of the user terminal 100 and the information providing apparatus 200 will be described in detail with reference to FIGS. 2 to 9.

FIG. 2 is a flowchart for describing a method of providing interior information according to an embodiment.

In operation S210, the information providing apparatus 200 identifies a type of accessories included in the query image received from the user terminal 100. Here, an accessory may be a tangible thing having a certain shape. For example, accessories may include various things that may be arranged in a predetermined space, such as a dining table, a refrigerator, a TV, a curtain, a sofa, a carpet, and a mat.

In an embodiment, the information providing apparatus 200 may identify a type of accessories included in a query image based on a deep neural network (DNN) trained based on training data. The DNN may include, but is not limited to, a convolutional neural network (CNN).

The information providing apparatus 200 may identify a type of accessories from a query image through various known image analysis methods in addition to a method of analyzing an image based on DNN.

According to an embodiment, when text data or video data is received as a query, the information providing apparatus 200 may identify a type of accessories through text analysis or frame analysis.

In an embodiment, the information providing apparatus 200 may receive a color image as a query image. When a black and white image is received from the user terminal 100, the information providing apparatus 200 may transmit a message to replace the black and white image with a color image to the user terminal 100.

In operation S220, the information providing apparatus 200 determines a type of space corresponding to the query image from a type of accessories identified in the query image.

The information providing apparatus 200 may compare a type of accessories suitable for each space with a type of accessories identified in the query image to determine which type of space the query image is captured for. The information providing apparatus 200 may store information of accessories suitable for each space in advance.

For example, when a refrigerator, a dining table, and a chair exist as accessories suitable for a kitchen, and a TV, a sofa, and a bookshelf exist as accessories suitable for a living room and when the dining table and the chair are identified from the query image, the information providing apparatus 200 may determine that the query image is captured for a kitchen.

In operation S230, the information providing apparatus 200 selects a reference image classified as corresponding to a type of space determined in operation S220 from pre-stored reference images.

For example, when it is determined that a query image is captured for a kitchen, the information providing apparatus 200 may select a reference image classified as a kitchen from the reference images.

The information providing apparatus 200 stores information indicating which type of space each of several reference images is captured for. The reference images are images related to companies that sell accessories or perform interior construction, and the information providing apparatus 200 may collect and store reference images on a shopping website or the like. Therefore, each of the reference images may be related to accessories being sold (or rented) or construction companies that advertise construction.

In operation S240, the information providing apparatus 200 transmits, to the user terminal 100, information related to the reference image selected in operation S230 as interior information.

In an embodiment, the information providing apparatus 200 may transmit information on accessories included in the reference image to the user terminal 100. The information on the accessories may include information on at least one of a name, an image, a price, a sales site address, and a user evaluation of an accessory.

The information providing apparatus 200 may transmit, to the user terminal 100, information on a same type of accessory as the accessory identified from the query image among the accessories included in the reference image. In this case, the information providing apparatus 200 may modify the query image in such a way that the accessory identified in the query image is replaced with the accessory included in the reference image, and transmit the modified query image to the user terminal 100 as interior information. Accordingly, a user may easily check how well accessories fit in when changing the accessories arranged in his or her space to recommended accessories.

In an embodiment, when there are accessories that are not suitable for a type of space corresponding to the query image among the accessories identified in the query image, the information providing apparatus 200 may transmit the information on the accessory included in the reference image to the user terminal 100 together with information indicating the unsuitable accessory. According to an implementation example, the information providing apparatus 200 may correct the query image such that the unsuitable accessories identified in the query image are replaced with the accessory included in the reference image, and transmit the modified query image to the user terminal 100 as interior information.

In an embodiment, when the number of reference images classified into the space corresponding to the query image and the same type of space is plural, the information providing apparatus 200 may compare a size (e.g., width, breadth, and height) of a space in which a query image is captured with a size of a space in which a plurality of reference images are captured to select only a reference image having a predetermined size difference and transmit the information on the accessories included in the selected reference image to the user terminal 100.

In an embodiment, the information providing apparatus 200 may transmit the information on the construction company corresponding to the reference image to the user terminal 100. The information on the construction company may include information on at least one of a name of the construction company, a construction cost, construction performance of the construction company, a site address of the construction company, and a user evaluation of the construction company. The information providing apparatus 200 may synthesize a query image with a reference image to generate a synthesized image of a user's space that is the same as that constructed by the construction company, and may transmit the synthesized image to the user terminal 100 as interior information. Techniques for changing or synthesizing one image according to a style of another image are used in the image processing field, and therefore detailed description thereof will be omitted.

According to an embodiment, when selecting a reference image used as interior information provided to a user from the pre-stored reference images, the information providing apparatus 200 may consider not only a type of space but also an interior style, which will be described below.

In an embodiment, the information providing apparatus 200 may collect, analyze, and store reference images from various websites. For example, the website may include a sales site of an accessory, a website of a construction company, a website specializing in interior construction, and the like. Therefore, each of the reference images may be related to accessories being sold (or rented), construction companies that advertise construction, or the like. For example, after collecting various images of a website, the information providing apparatus 200 may identify a type of accessories in each image, determine a type of space in each image, and/or determine an interior style of each image. Such an operation of the information providing apparatus 200 may be performed similarly to analysis of a query image described in FIGS. 2 to 9.

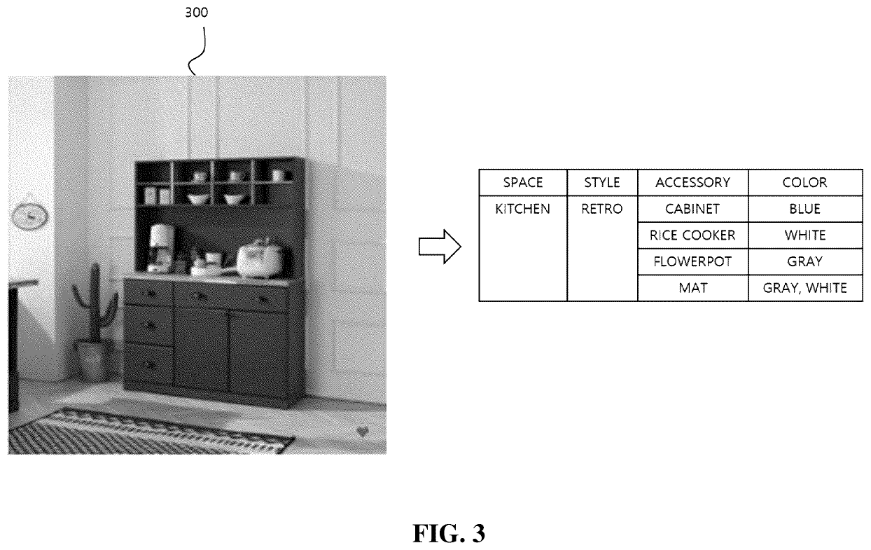

FIG. 3 is an exemplary diagram illustrating interior-related information extracted from a reference image 300.

The information providing apparatus 200 may acquire reference images in various ways. As described above, the information providing apparatus 200 may acquire reference images from shopping websites or may acquire reference images input by an administrator.

The information providing apparatus 200 may obtain interior-related information from reference images. The interior-related information may include information on at least one of a type of accessories included in the reference image, colors of accessories, a type of space corresponding to the reference image, and an interior style.

As illustrated in FIG. 3, the interior-related information of the reference image 300 may indicate that the type of the captured space is a kitchen, the interior style is a retro style, and the accessories include a blue cabinet, a white rice cooker, a gray flowerpot, and a gray/white mat.

As in identifying the type of accessories from the query image described above, the information providing apparatus 200 may analyze the reference image 300 by a predetermined image analysis method and identify a type of accessories included in the reference image 300. According to an implementation example, the type of accessories included in the reference image 300 may be determined by an administrator and then input to the information providing apparatus 200.

The type of space corresponding to the reference image 300 may be determined from a comparison result between the type of accessories identified in the reference image 300 and accessories suitable for each space, or may be determined by an administrator.

In an embodiment, the information providing apparatus 200 may analyze the reference image 300 by the predetermined image analysis method to identify the colors of the accessories included in the reference image 300. According to an implementation example, the colors of accessories included in the reference image 300 may be determined by an administrator, and then input to the information providing apparatus 200.

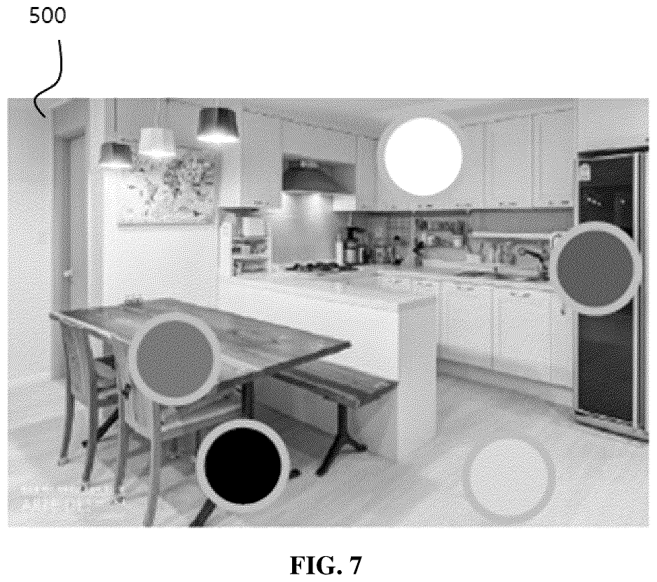

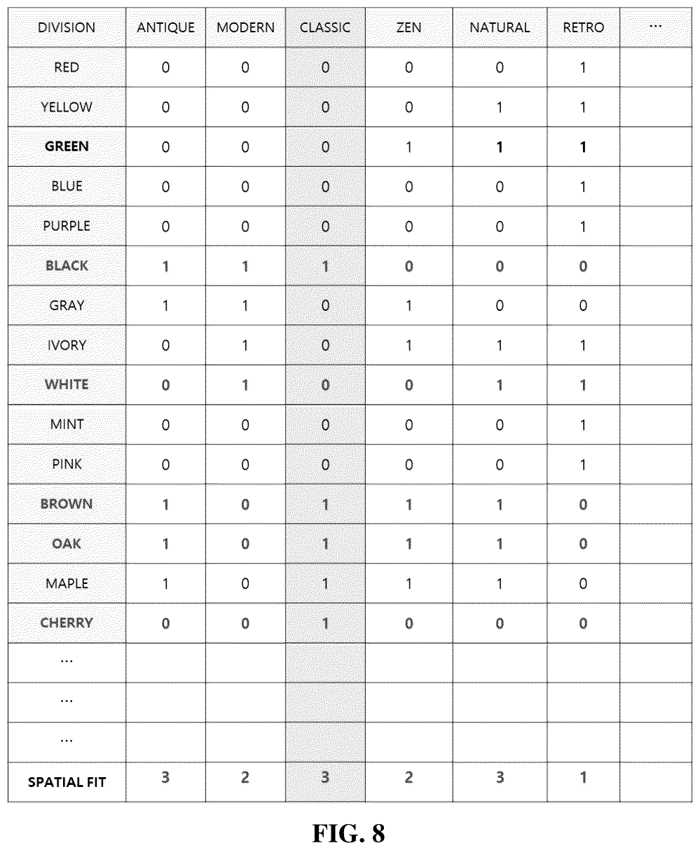

When the colors of the accessories in the reference image 300 are identified, the information providing apparatus 200 may determine the interior style based on the identified color, which will be described later with reference to FIGS. 7 and 8.

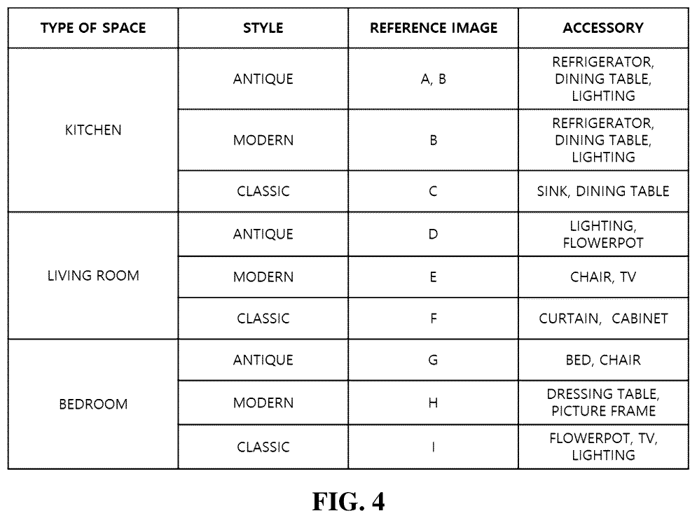

FIG. 4 is an exemplary diagram illustrating a classification result of reference images according to the interior-related information.

When the interior-related information corresponding to the reference images is acquired, the information providing apparatus 200 may classify each of the reference images according to the interior-related information. For example, the information providing apparatus 200 may classify the reference images according to the type of space and the interior style. The information providing apparatus 200 may store information on which accessories are included in the reference images classified according to the type of space and the interior style. According to an implementation example, the information providing apparatus 200 may further store size information of each accessory in the reference images.

As illustrated in FIG. 4, reference image A and reference image B may be captured for a kitchen and classified as having an antique style, and reference image D may be captured for a living room and classified as having an antique style. Also, it can be seen that reference image A and reference image B include a refrigerator, a dining table, and lighting as accessories, and reference image C includes a sink and a dining table as accessories. Since any one reference image does not correspond to only one interior style, the reference image may be classified as having an antique style and a modern style as in the case of the reference image B.

When the query image received from the user terminal 100 is captured for a kitchen, the information providing apparatus 200 may provide information on accessories included in at least one of the reference images A, B, and C classified as the kitchen, and may transmit, for example, information on a refrigerator to the user terminal 100.

As another example, when the query image received from the user terminal 100 is captured for a living room and an interior style of a query image is a modern style, the information providing apparatus 200 may transmit information on an accessory included in reference image E classified as the living room and the modern style, for example, information on a chair, to the user terminal 100.

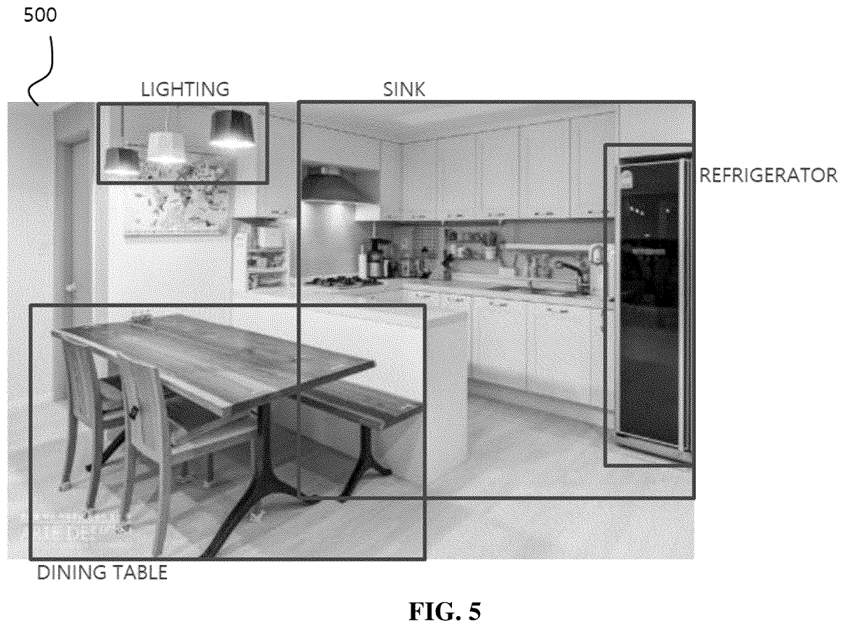

Hereinafter, a method of determining a type of space corresponding to a query image and an interior style of the query image will be described with reference to FIGS. 5 to 8.

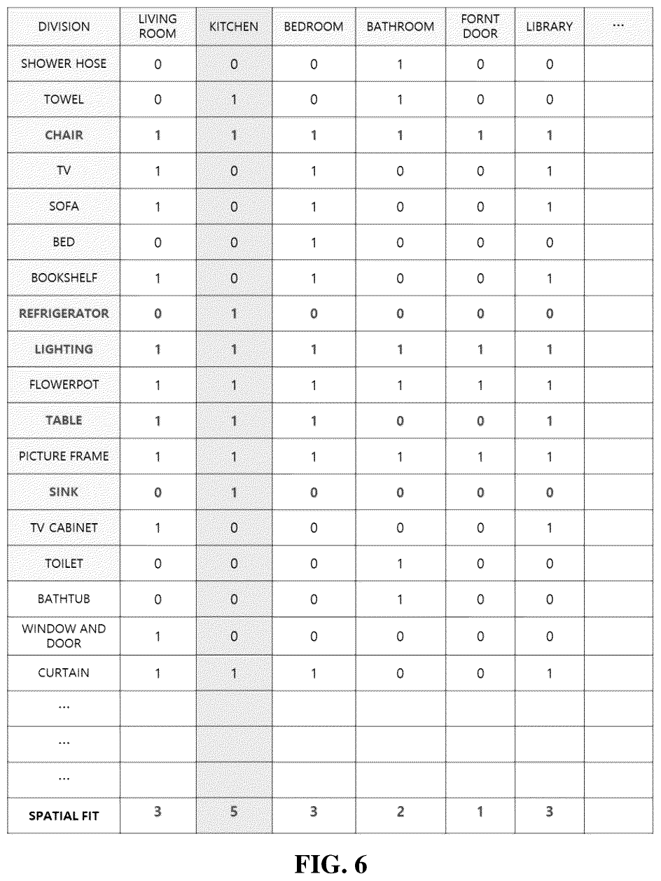

FIG. 5 is an exemplary view illustrating a type of accessories identified in a query image 500, and FIG. 6 is a diagram for describing a method of determining a type of space corresponding to the query image 500 based on the type of accessories identified in the query image 500.

The information providing apparatus 200 may identify the type of accessories included in the query image through the image analysis method. As illustrated in FIG. 5, as the accessories included in the query image 500, lighting, a dining table, a sink, and a refrigerator may be identified.

When the type of accessories is identified in the query image 500, the information providing apparatus 200 compares the type of accessories suitable for each space with the type of accessories in the query image 500 to determine the type of space corresponding to the query image 500.

As illustrated in FIG. 6, the information providing apparatus 200 may store information indicating which types of accessories are suitable for each space. For example, in the case of a living room, a chair, a TV, a sofa, a bookshelf, etc., (accessories marked with 1) are suitable accessories, and a shower hose, a faucet, a bed, etc., (accessories marked with 0) are unsuitable accessories.

The information providing apparatus 200 may calculate a spatial fit for each space indicating which type of space the accessories identified in the query image 500 are suitable for, and determine the type of space corresponding to the query image 500 according to the calculated spatial fit.

Specifically, the information providing apparatus 200 may calculate, as the spatial fit, the number of accessories identical to the accessories identified in the query image 500 among suitable accessories for each space. Accordingly, it can be seen that the spatial fit for the query image 500 for a living room is 3 points, while the spatial fit for a kitchen is 5 points. That is, since the fit for the kitchen is the highest, the information providing apparatus 200 may determine the kitchen as the type of space corresponding to the query image 500.

FIG. 7 is an exemplary view illustrating colors of accessories identified in the query image 500, and FIG. 8 is a diagram for describing a method of determining the interior style of the query image 500 based on the colors identified in the query image 500.

The information providing apparatus 200 may identify the colors of accessories included in the query image through the image analysis method. As illustrated in FIG. 7, cherry, white, brown, black, and oak may be identified as colors of accessories included in the query image 500.

When the colors of accessories are identified in the query image 500, the information providing apparatus 200 compares the type of colors suitable for each interior style with the colors of accessories in the query image 500 to determine the interior style corresponding to the query image 500.

As illustrated in FIG. 8, the information providing apparatus 200 may store information indicating which color is suitable for each interior style. For example, in the case of the antique style, black, gray, brown, oak, and maple (colors marked with 1) are suitable colors, and red, yellow, green, blue, etc., (colors marked with 0) are unsuitable colors.

The information providing apparatus 200 may calculate style fit indicating which type of interior styles the colors of the accessory identified in the query image 500 are suitable for, and determine the interior style corresponding to the query image 500 according to the calculated fit.

Specifically, the information providing apparatus 200 may calculate the number of colors identical to the colors identified in the query image 500 among suitable colors for each interior style as the style fit. When cherry, white, brown, black, and oak are identified in the query image 500, it can be seen that the style fit for the antique style is 3 points, whereas the fit for the classic style of these colors is 4 points. That is, since the fit for the classic style is highest, the information providing apparatus 200 may determine the classic style as the interior style corresponding to the query image 500.

When the interior style corresponding to the query image is determined, the information providing apparatus 200 may transmit information on a reference image classified as having the same style to the user terminal 100. When both the type of space and the interior style corresponding to the query image are determined, the information on the reference image classified as having the same style while corresponding to the same type of space may be transmitted to the user terminal 100. As described above, the information on the reference image may include the information on the accessory and/or the information on the construction company.

In an embodiment, the information providing apparatus 200 may select an accessory unsuitable for the interior style of the query image from the accessories included in the query image. For example, when the interior style of the query image is a classic style and a color of a refrigerator included in the query image is red that is unsuitable for the classic style, the refrigerator may be selected as an unsuitable product.

The information providing apparatus 200 may transmit information on the same type of accessory as the unsuitable accessory among the accessories included in the reference image to the user terminal 100. For example, when a color of a dining table among the accessories in the query image 500 illustrated in FIG. 7 does not match the classic style, the information providing apparatus 200 may transmit, to the user terminal 100, the information on the dining table among the accessories included in the reference image of the classic style. According to an implementation example, the information providing apparatus 200 may correct or synthesize the query image such that the dining table included in the query image 500 is replaced with the dining table included in the reference image, and may also transmit the modified or synthesized query image to the user terminal 100.

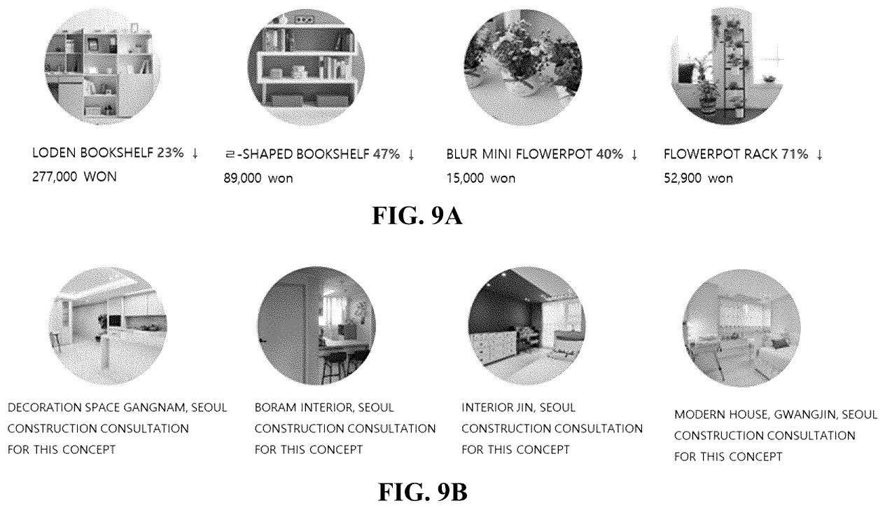

FIG. 9A is an exemplary diagram illustrating information on an accessory provided to the user terminal 100, and FIG. 9B is an exemplary diagram illustrating information on a construction company provided to the user terminal 100.

As illustrated in FIG. 9A, the information providing apparatus 200 may provide, as the information on the accessory, names and price information of each accessory to the user terminal 100. When transmitting information on a specific accessory to the user terminal 100, the information providing apparatus 200 may transmit link information for a website sold by the lowest price among several sales websites or link information for a website having the highest number of sales to the user terminal 100. When the information on the accessory is provided to the user terminal 100, the user terminal 100 may display the information on the accessory on a screen, and may access a sales website of a specific accessory according to the user's selection.

In addition, as illustrated in FIG. 9B, the information providing apparatus 200 may provide names and price information of each construction company to the user terminal 100 as information on a construction company. When the information on the construction company is provided to the user terminal 100, the user terminal 100 may display the information on the construction company on the screen, and may access a website of a specific company according to the user's selection.

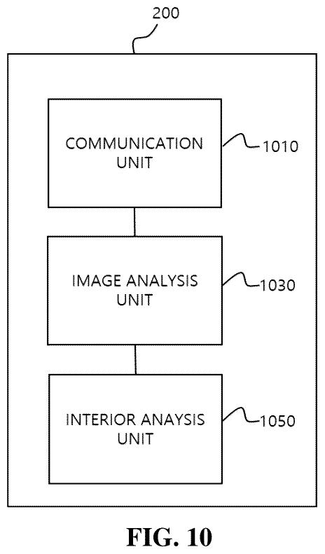

FIG. 10 is a block diagram illustrating a configuration of the information providing apparatus 200 according to the embodiment.

Referring to FIG. 10, the information providing apparatus 200 includes a communication unit 1010, an image analysis unit 1030, and an interior analysis unit 1050.

The communication unit 1010, the image analysis unit 1030, and the interior analysis unit 1050 may be implemented with at least one processor and may operate according to a program stored in a memory (not illustrated).

The communication unit 1010 transmits and receives data to and from the user terminal 100. Specifically, the communication unit 1010 receives a query from the user terminal 100, and transmits interior information derived from the interior analysis unit 1050 to the user terminal 100.

The image analysis unit 1030 analyzes a query image received from the user terminal 100. Specifically, the image analysis unit 1030 may identify types and colors of accessories included in the query image. In an embodiment, the image analysis unit 1030 may store a DNN for image analysis, and the DNN may be trained to identify the types and colors of accessories from several pieces of training data.

The interior analysis unit 1050 compares pre-stored reference images with analysis results of the query image to generate the interior information to be provided to the user terminal 100.

The interior analysis unit 1050 may determine the type of space and the interior style corresponding to the query image from the types and colors of accessories included in the query image, and select some reference images based on the classification result of the reference images. Further, the interior analysis unit 1050 may transmit the interior information corresponding to the selected reference image to the user terminal 100 through the communication unit 1010. The interior information may include accessory information and/or information on a construction company related to the reference image.

In an embodiment, the information providing apparatus 200 may receive, from the user terminal 100, the type of space and the information on the interior style that a user wants to decorate. That is, a user may select the type of space and the interior style that he or she is interested in instead of inputting the query image. A user may also select a theme color he or she wants along with the interior style.

The information providing apparatus 200 may select a reference image classified as having the interior style selected by the user while having the same type as the space selected by the user, and may transmit information corresponding to the selected reference image to the user terminal 100. When the theme color is input together from the user terminal 100, the information providing apparatus 200 may transmit information corresponding to a reference image classified as having the corresponding theme color to the user terminal 100.

In another embodiment, the information providing apparatus 200 may receive the query image and the information on the interior style desired by the user from the user terminal 100. The information providing apparatus 200 may select a reference image classified as having the interior style selected by the user while having the same space as the space corresponding to the query image, and may transmit information corresponding to the selected reference image to the user terminal 100.

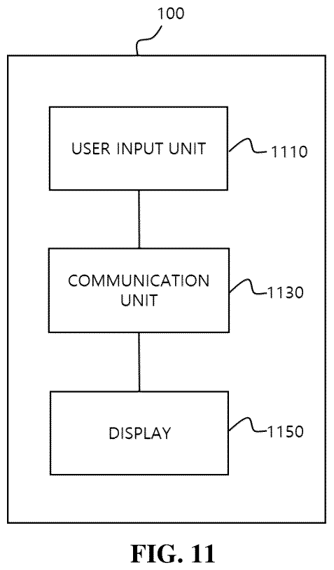

FIG. 11 is a block diagram illustrating a configuration of the user terminal 100 according to the embodiment.

Referring to FIG. 11, the user terminal 100 may include a user input unit 1110, a communication unit 1130, and a display 1150.

The user input unit 1110 is used to receive a predetermined instruction from a user. For example, the user input unit 1110 may include a touch screen, a keyboard, a mouse, or the like, but is not limited thereto.

The communication unit 1130 transmits and receives data to and from the information providing apparatus 200. Specifically, the communication unit 1130 transmits a query to the information providing apparatus 200 according to a user input and receives interior information from the information providing apparatus 200.

The display 1150 displays the interior information received from the information providing apparatus 200 on a screen. When a user selects the interior information displayed on the screen by a method such as a touch, the communication unit 1130 may access a website selling an accessory or a website of a construction company.

Meanwhile, the above-described embodiments of the present invention may be written as a program that may be executed on a computer, and the written program may be stored in a medium.

The medium may continuously store a computer-executable program, or may be a temporary storage for execution or download. In addition, the medium may be any of various types of recording means or storage means in the form of single hardware or in the form of several pieces of hardware combined, and may not be limited to a medium directly connected to any computer system, but may be distributed on a network. Examples of the medium may include those configured to store and execute program commands, including magnetic media such as a hard disk, a floppy disk, and a magnetic tape, optical recording media such as a compact disc read only memory (CD-ROM) and a digital versatile disc (DVD), a magneto-optical medium such as a floptical disk, a read only memory (ROM), a random access memory (RAM), a flash memory, and the like. In addition, examples of other media include recording media or storage media managed by app stores that distributes applications, sites that supply or distribute other various software, and servers.

According to an apparatus for providing interior information and a method of providing interior information by the same according to an embodiment of the present invention, it is possible to provide information on an interior suitable for a user's residential space.

In addition, according to an apparatus for providing interior information and a method of providing interior information by the same according to an embodiment of the present invention, it is possible to activate a user's purchase of accessories or a user's selection of a construction company by providing information that reflects the user's preferences.

However, effects that may be achieved by the interior information providing apparatus and the interior information providing method according to embodiments of the present invention are not limited to the above-described effects, and other effects that are not described may be clearly understood by those of ordinary skill in the art to which the present invention belongs from the above detailed description.

Hereinabove, the technical idea of the present invention has been described in detail with reference to exemplary embodiments, but the technical idea of the present invention is not limited to the above embodiments, and various modifications and changes within the scope of the technical spirit of the present invention are possible for those skilled in the art.

What is claimed is:

1. A method of providing interior information by an apparatus for providing interior information, the method comprising:
identifying a type of accessory included in a query image received from a user terminal;
determining a type of space corresponding to the query image from the identified type of accessory;
selecting a reference image classified as corresponding to the determined type of space from pre-stored reference images; and
transmitting information on an accessory included in the selected reference image to the user terminal.

2. The method of claim 1, wherein the determining of the type of space corresponding to the query image includes determining a type of space corresponding to the query image by comparing a type of accessory suitable for each space with the type of accessory included in the query image.

3. The method of claim 1, wherein the transmitting of the information on the accessory to the user terminal includes transmitting, to the user terminal, information on a same type of accessory as the identified accessory from accessories included in the selected reference image.

4. The method of claim 1, further comprising:
identifying a color of the accessory included in the query image; and
determining an interior style of the query image from the identified color of the accessory,
wherein the transmitting of the information on the accessory to the user terminal includes transmitting, to the user terminal, the information on the accessory that corresponds to the determined type of space and is included in a reference image classified as having the determined interior style.

5. The method of claim 4, further comprising transmitting, to the user terminal, information on a construction company that corresponds to the determined type of space and corresponds to the reference image classified as having the determined interior style.

6. The method of claim 4, wherein the transmitting of the information on the accessory to the user terminal includes:
selecting an accessory unsuitable for the identified interior style from the accessories included in the query image; and
transmitting, to the user terminal, information on a same type of accessory as the unsuitable accessory from accessories included in the selected reference image.

7. The method of claim 4, wherein the determining of the interior style of the query image includes determining the interior style of the query image by comparing a color suitable for each interior style with the color of the accessory included in the query image.

8. The method of claim 1, further comprising:
receiving information on an interior style from the user terminal; and
transmitting, to the user terminal, information on a construction company that corresponds to the determined type of space and corresponds to a reference image classified as having the received interior style.

9. An apparatus for providing interior information, comprising:
an image analysis unit configured to identify a type of accessory included in a query image received from a user terminal;
an interior analysis unit configured to determine a type of space corresponding to the query image from the identified type of accessory and select a reference image classified as corresponding to the determined type of space from pre-stored reference images; and
a communication unit configured to transmit information on the accessory included in the selected reference image to the user terminal.

10. The apparatus of claim 9, wherein the interior analysis unit determines the type of space corresponding to the query image by comparing a type of accessory suitable for each space with the type of accessory included in the query image.

11. The apparatus of claim 9, wherein the communication unit transmits, to the user terminal, information of a same type of accessory as the identified accessory from the accessories included in the selected reference image.

12. The apparatus of claim 9, wherein the image analysis unit identifies a color of the accessory included in the query image,
the interior analysis unit determines an interior style of the query image from the identified color of the accessory, and
the communication unit transmits, to the user terminal, information on an accessory that corresponds to the determined type of space and is included in a reference image classified as having the determined interior style.

13. The apparatus of claim 12, wherein the communication unit transmits, to the user terminal, information on an accessory that corresponds to the determined type of space and corresponds to information on a construction company corresponding to the reference image classified as having the determined interior style.

14. The apparatus of claim 12, wherein the interior analysis unit determines an interior style of the query image by comparing a color suitable for each interior style with the color of the accessory included in the query image.

15. The apparatus of claim 9, wherein the communication unit receives information on an interior style from the user terminal, and transmits, to the user terminal, information on a construction company that corresponds to the determined type of space and corresponds to a reference image classified as having the received interior style.
